(19) United States
(12) Patent Application Publication
(10) Pub. No.: US 2026/0213600 A1
(43) Pub. Date: Jul. 23, 2026

(54) ROTARY ELECTRICAL MACHINE

(71) Applicant: Panasonic Intellectual Property Management Co., Ltd., Osaka (JP)

(72) Inventors: ATSUFUMI KIKUCHI, Osaka (JP); KAZUYUKI SAKIYAMA, Osaka (JP)

(21) Appl. No.: 19/138,758

(22) PCT Filed: Dec. 25, 2023
(86) PCT No.: PCT/JP2023/046431

§ 371 Date: Jun. 13, 2025

(30) Foreign Application Priority Data
Jan. 23, 2023 (JP) 2023-008063

(51) Int. Cl. H02K 3/42; H02K 1/14; H02K 1/20; H02K 1/278; H02K 21/16

(52) U.S. Cl. CPC H02K 3/42; H02K 1/146; H02K 1/20; H02K 1/278; H02K 21/16

(57) ABSTRACT

Provided is a rotary electrical machine capable of suppressing an increase in eddy current in the rotary electrical machine and significantly reducing a loss of a coil. The rotary electrical machine includes a stator having a coil and a first magnetic core, and a rotor having a permanent magnet and a second magnetic core. The rotary electrical machine includes a magnetic structure provided in at least one of two coil end portions that are both ends of the coil, the magnetic structure inducing magnetic flux directed from the second magnetic core toward the first magnetic core. Here, the magnetic structure guides the magnetic flux directed from the second magnetic core to the first magnetic core in a radial direction of the rotary electrical machine and guides the magnetic flux in a circumferential direction of the rotary electrical machine. In addition, the magnetic structure is provided such that the magnetic flux does not substantially interlink with the coil.

### TECHNICAL FIELD

The present disclosure relates to a rotary electrical machine (also referred to as a rotary machine) such as a motor and a power generator.

### BACKGROUND ART

For example, in PTL 1, in a slotless rotary machine according to a comparative example, in order to solve a problem that an inductance of a stator winding of a slotless rotary machine of a stator is small, a method for controlling a current value by continuously applying a pulse voltage by using an inductance component of the winding, that is, a first-order lag characteristics of the current and controlling the current value to appear to be a continuous sinusoidal current is used as PWM control. Here, in order to solve the above problem, the invention according to PTL 1 is characterized in that a soft magnetic member is provided at a coil end portion to increase a leakage inductance of the winding.

### CITATION LIST

### Patent Literature

PTL 1: Unexamined Japanese Patent Publication No. 2020-061853

### SUMMARY OF THE INVENTION

In the rotary electrical machine, there is a problem that a loss of the coil at the coil end portion of the stator winding increases. The loss of the coil is caused by an eddy current, and the following factors are considered as factors of increasing the eddy current.
(1) Increase in frequency of current flowing through stator winding and increase in rotation speed are achieved.
(2) Increase in induced electromotive force (electromotive force of eddy current) due to leakage magnetic flux at coil end portion.
(3) Increase in leakage magnetic flux of coil end portion due to size reduction.

An object of the present disclosure is to provide a rotary electrical machine capable of suppressing an increase in eddy current in the rotary electrical machine and significantly reducing a loss of a coil.

A rotary electrical machine according to one aspect of the present disclosure includes a stator including a coil and a first magnetic core, and a rotor including a permanent magnet and a second magnetic core.

A magnetic structure provided in at least one of two coil end portions that are both ends of the coil, the magnetic structure inducing magnetic flux directed from the second magnetic core to the first magnetic core.

In the rotary electrical machine, the magnetic structure guides the magnetic flux directed from the second magnetic core to the first magnetic core in a radial direction of the rotary electrical machine and guides the magnetic flux in a circumferential direction of the rotary electrical machine.

In addition, in the rotary electrical machine, the magnetic structure is provided, and the magnetic flux does not substantially interlink with the coil.

Therefore, in accordance with the rotary electrical machine according to one aspect of the present disclosure, the increase in induced electromotive force (electromotive force of the eddy current) due to the leakage magnetic flux in the coil end portion and the increase in leakage magnetic flux in the coil end portion due to the size reduction are suppressed, and the eddy current loss in the coil can be reduced. As a result, the loss of the coil can be significantly reduced.

### BRIEF DESCRIPTION OF THE DRAWINGS

FIG. 1A is a perspective view illustrating an appearance of a rotary electrical machine according to a comparative example.

FIG. 1B is a perspective view illustrating an appearance of stator 10 in FIG. 1A.

FIG. 1C is a perspective view illustrating an appearance of rotor 20 in FIG. 1A.

FIG. 2A is a plan view of the rotary electrical machine of FIG. 1A.

FIG. 2B is a longitudinal sectional view taken along line A-A′ in FIG. 2A.

FIG. 3A is a top view illustrating main magnetic flux lines flowing in a magnetic material in the rotary electrical machine of FIG. 1A.

FIG. 3B is a longitudinal sectional view illustrating that magnetic flux lines leaking to a coil end portion interlink with a coil in the rotary electrical machine of FIG. 1A to generate an eddy current.

FIG. 3C is a perspective view illustrating that the magnetic flux lines leaking to the coil end portion interlink with the coil in the rotary electrical machine of FIG. 1A to generate the eddy current.

FIG. 4 is a perspective view illustrating a configuration example of one sector of a rotary electrical machine according to a first exemplary embodiment.

FIG. 5A is a see-through perspective view of one sector of the rotary electrical machine illustrating magnetic flux density vector 85 of magnetic flux lines leaking to a coil end portion when a rotation angle of a rotor is 0 degrees, which is a simulation result of the rotary electrical machine of FIG. 1A.

FIG. 5B is a see-through top view of the simulation result of FIG. 5A.

FIG. 5C is a see-through side view of the simulation result of FIG. 5A.

FIG. 6A is a see-through perspective view of one sector of the rotary electrical machine illustrating magnetic flux density vector 86 of magnetic flux lines leaking to the coil end portion when the rotation angle of the rotor is 7.5 degrees, which is a simulation result of the rotary electrical machine of FIG. 1A.

FIG. 6B is a see-through top view of the simulation result of FIG. 6A.

FIG. 6C is a see-through side view of the simulation result of FIG. 6A.

FIG. 7A is a see-through perspective view of one sector of the rotary electrical machine illustrating magnetic flux density vector 87 of magnetic flux lines leaking to the coil end portion when the rotation angle of the rotor is 15 degrees, which is a simulation result of the rotary electrical machine of FIG. 1A.

FIG. 7B is a see-through perspective top view of the simulation result of FIG. 7A.

FIG. 7C is a see-through side view of the simulation result of FIG. 7A.

FIG. 8A is a see-through perspective view of one sector of the rotary electrical machine illustrating an analysis result of an eddy current in a coil in a rotating magnetic field by a magnet of a rotor, which is a simulation result of the rotary electrical machine of FIG. 1A.

FIG. 8B is a see-through top view of the simulation result of FIG. 8A.

FIG. 9A is a perspective view illustrating a configuration of one sector of a rotary electrical machine according to a comparative example.

FIG. 9B is a perspective view illustrating a configuration of one sector of the rotary electrical machine according to the first exemplary embodiment.

FIG. 10A is a perspective view illustrating a distribution in which a current density is more than or equal to 1×10⁶ (A/m²) when the rotation angle of the rotor is 0 degrees in monochrome contour line display, which is a simulation result of one sector of the rotary electrical machine in FIG. 9A.

FIG. 10B is a top view of the simulation result of FIG. 10A.

FIG. 11A is a perspective view illustrating a distribution in which the current density is more than or equal to 1×10⁶ (A/m²) when the rotation angle of the rotor is 7.5 degrees in monochrome contour line display, which is a simulation result of one sector of the rotary electrical machine in FIG. 9A.

FIG. 11B is a top view of the simulation result of FIG. 11A.

FIG. 12A is a perspective view illustrating a distribution in which the current density is more than or equal to 1×10⁶ (A/m²) when the rotation angle of the rotor is 15 degrees in monochrome contour line display, which is a simulation result of one sector of the rotary electrical machine in FIG. 9A.

FIG. 12B is a top view of the simulation result of FIG. 12A.

FIG. 13A is a perspective view illustrating a distribution in which the current density is more than or equal to 1×10⁶ (A/m²) when the rotation angle of the rotor is 0 degrees in monochrome contour line display, which is a simulation result of one sector of the rotary electrical machine in FIG. 9B.

FIG. 13B is a top view of the simulation result of FIG. 13A.

FIG. 14A is a perspective view illustrating a distribution in which the current density is more than or equal to 1×10⁶ (A/m²) when the rotation angle of the rotor is 7.5 degrees in monochrome contour line display, which is a simulation result of one sector of the rotary electrical machine in FIG. 9B.

FIG. 14B is a top view of the simulation result of FIG. 14A.

FIG. 15A is a perspective view illustrating a distribution in which the current density is more than or equal to 1×10⁶ (A/m²) when the rotation angle of the rotor is 15 degrees in monochrome contour line display, which is a simulation result of one sector of the rotary electrical machine in FIG. 9B.

FIG. 15B is a top view of the simulation result of FIG. 15A.

FIG. 16A is a perspective view illustrating a distribution in which a distribution in which an eddy current loss per unit area is more than or equal to 1×10⁴ (W/m³) in monochrome contour line display, which is a simulation result of one sector of the rotary electrical machine of FIG. 9A.

FIG. 16B is a perspective view illustrating a distribution in which a distribution in which the eddy current loss per unit area is more than or equal to 1×10⁴ (W/m′) in monochrome contour line display, which is a simulation result of one sector of the rotary electrical machine of FIG. 9B.

FIG. 17A is a perspective view illustrating the configuration of one sector of the rotary electrical machine according to the comparative example of FIG. 9A.

FIG. 17B is a top view of the rotary electrical machine of FIG. 17A.

FIG. 17C is a side view of the rotary electrical machine of FIG. 17A.

FIG. 17D is a front view of the rotary electrical machine of FIG. 17A.

FIG. 18A is a perspective view illustrating the configuration of one sector of the rotary electrical machine according to the first exemplary embodiment in FIG. 9B.

FIG. 18B is a top view of the rotary electrical machine of FIG. 18A.

FIG. 18C is a side view of the rotary electrical machine of FIG. 18A.

FIG. 18D is a front view of the rotary electrical machine of FIG. 18A.

FIG. 19A is a perspective view illustrating a configuration of one sector of a rotary electrical machine according to a second exemplary embodiment.

FIG. 19B is a top view of the rotary electrical machine of FIG. 19A.

FIG. 19C is a side view of the rotary electrical machine of FIG. 19A.

FIG. 19D is a front view of the rotary electrical machine of FIG. 19A.

FIG. 20A is a perspective view illustrating a configuration of one sector of a rotary electrical machine according to a third exemplary embodiment.

FIG. 20B is a top view of the rotary electrical machine of FIG. 20A.

FIG. 21A is a perspective view illustrating a configuration of one sector of a rotary electrical machine according to a fourth exemplary embodiment.

FIG. 21B is a top view of the rotary electrical machine of FIG. 21A.

FIG. 22A is a perspective view illustrating a configuration of one sector of a rotary electrical machine according to a fifth exemplary embodiment.

FIG. 22B is a perspective view of a magnetic structure of the rotary electrical machine of FIG. 22A.

FIG. 22C is a perspective view of the magnetic structure of the rotary electrical machine of FIG. 22 A when the magnetic structure is turned upside down.

FIG. 22D is a top view of the rotary electrical machine of FIG. 22A.

FIG. 23A is a perspective view illustrating a configuration of one sector of a rotary electrical machine according to a sixth exemplary embodiment.

FIG. 23B is a top view of the rotary electrical machine of FIG. 23A.

FIG. 24A is a perspective view illustrating a configuration of one sector of a rotary electrical machine according to a seventh exemplary embodiment.

FIG. 24B is a top view of the rotary electrical machine of FIG. 24A.

### DESCRIPTION OF EMBODIMENT

Hereinafter, exemplary embodiments and modifications according to the present disclosure are described with reference to the drawings. Note that, the same or similar components are denoted by the same reference marks.

### Findings of Inventors

### Comparative Example

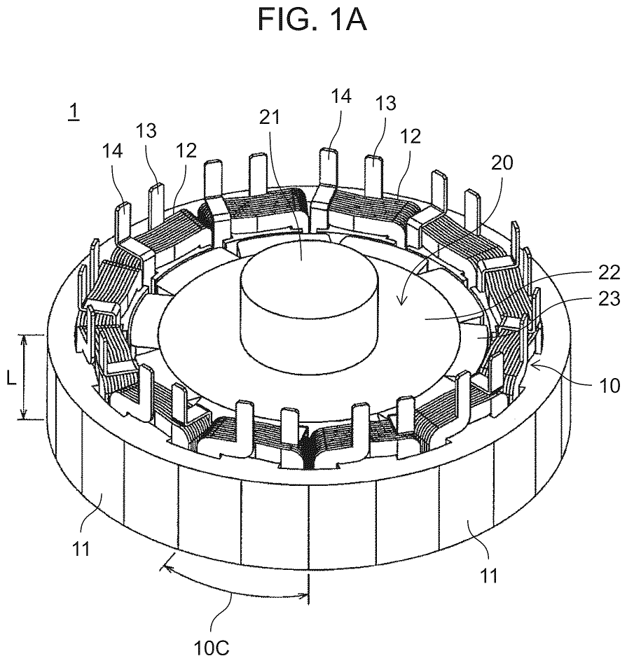

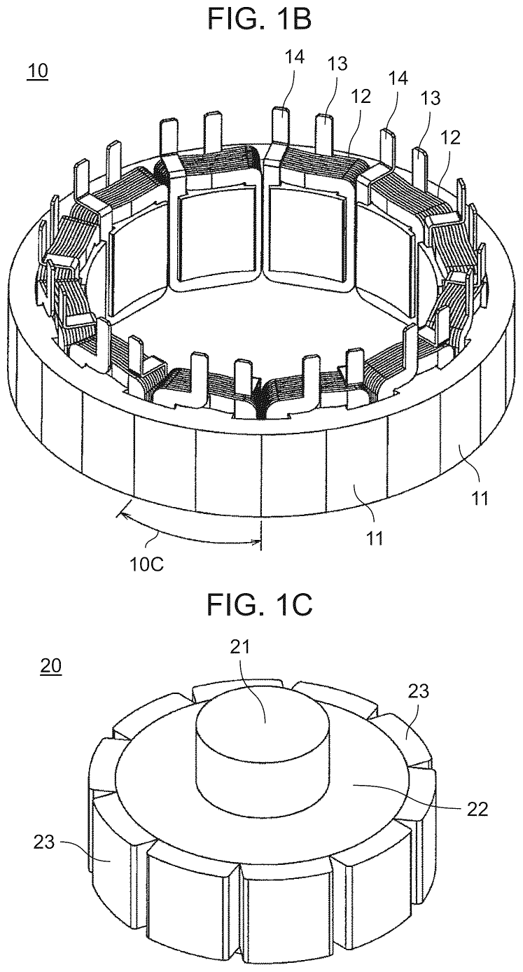

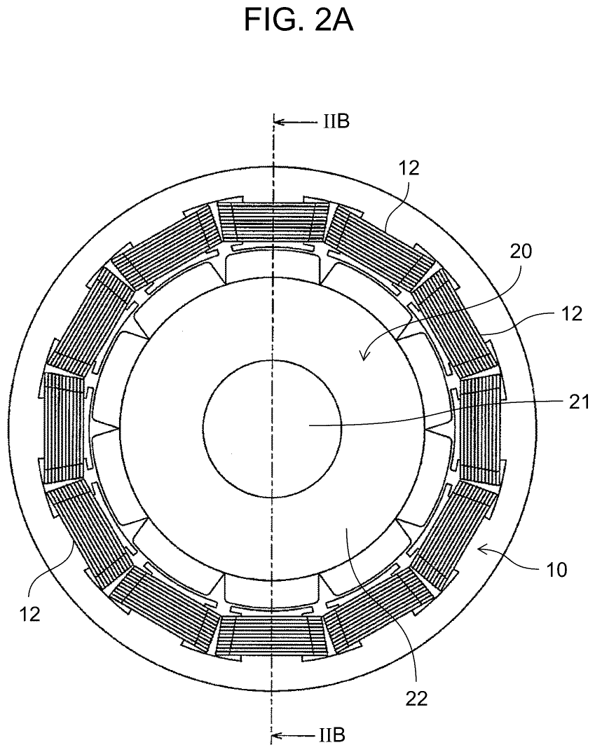

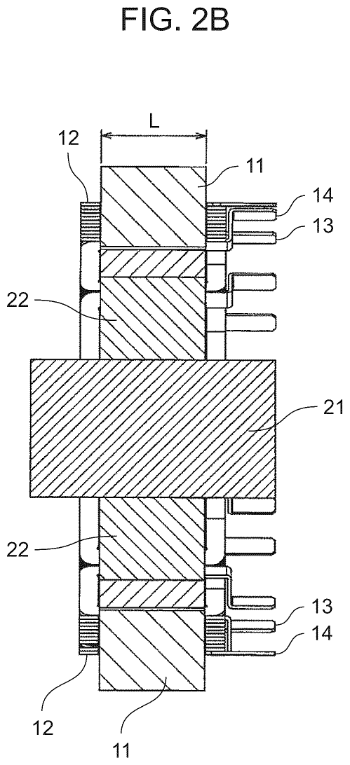

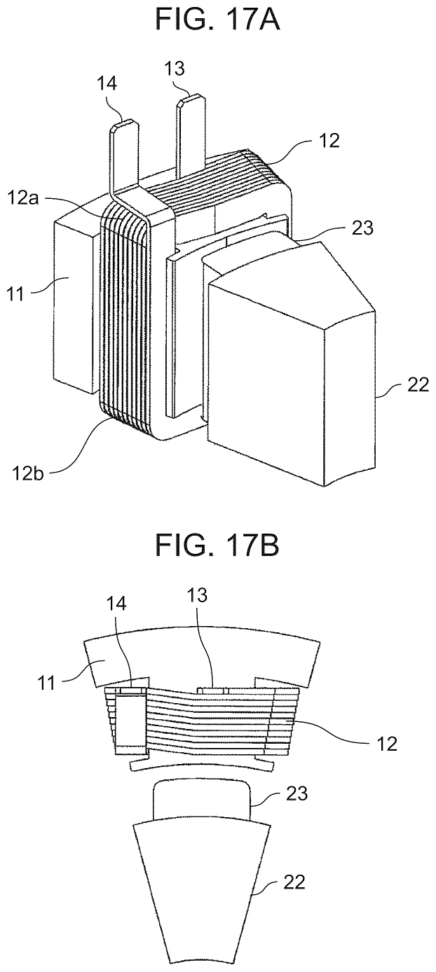

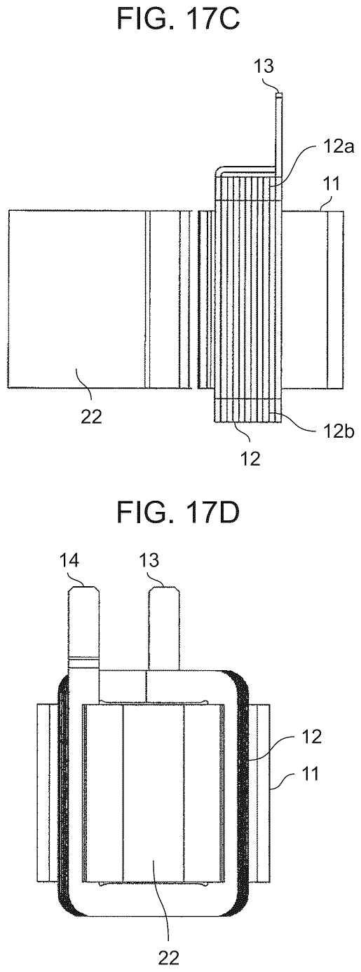

FIG. 1A is a perspective view illustrating an external appearance of a rotary electrical machine according to a comparative example, FIG. 1B is a perspective view illustrating an external appearance of stator 10 in FIG. 1A, and FIG. 1C is a perspective view illustrating an external appearance of rotor 20 in FIG. 1A. In addition, FIG. 2A is a plan view of the rotary electrical machine of FIG. 1A, and FIG. 2B is a longitudinal sectional view of plane A-A′ of FIG. 2A. Further, details of a structure of one sector of the rotary electrical machine are illustrated in FIGS. 17A to 17D.

In FIGS. 1A to 1C and 2A to 2B, the rotary electrical machine of FIG. 1A is a slotless rotary electrical machine including stator 10 of FIG. 1B and rotor 20 of FIG. 1C, and is configured such that rotor 20 is rotatably inserted into a hollow of a cylinder of stator 10. Stator 10 includes, for example, 12 sectors 10C, and includes a plurality of coils 12 made of conductors and a plurality of magnetic cores 11 made of a magnetic material.

Coil 12 has terminals 13 and 14 protruding upward, for example, at both ends thereof. For example, 12 coils 12 are juxtaposed in a cylindrical shape inside the cylinder of stator 10, and for example, 24 magnetic cores 11 are juxtaposed such that a part of magnetic core 11 is inserted and fitted into a hollow portion of a substantially rectangular cylinder of each coil 12 outside juxtaposed 12 coils 12. In addition, in rotor 20, rotary shaft 21 is inserted into a hollow of a cylinder of magnetic core 22 made of a magnetic material having a cylindrical shape, and for example, 12 permanent magnets 23 are juxtaposed on an outer periphery of magnetic core 22.

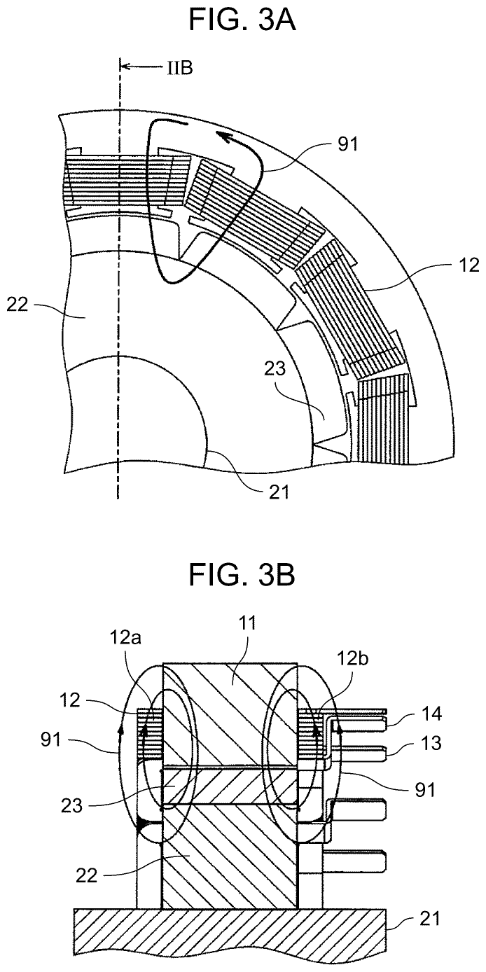

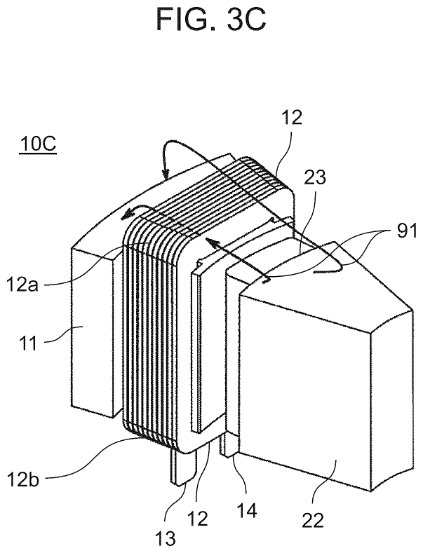

Here, it is possible to reduce a size by reducing a length L of the rotary electrical machine in an axial direction. However, a case where a loss increases with the size reduction will be described below with reference to FIGS. 3A and 3B.

FIG. 3A is a top view illustrating main magnetic flux lines flowing in the magnetic material in the rotary electrical machine of FIG. 1A, FIG. 3B is a longitudinal sectional view illustrating that magnetic flux lines leaking to coil end portions in the rotary electrical machine of FIG. 1A are interlinked with a coil to generate an eddy current, and FIG. 3C is a perspective view illustrating that the magnetic flux lines leaking to the coil end portions in the rotary electrical machine of FIG. 1A are interlinked with the coil to generate the eddy current.

In FIG. 3A, main magnetic flux lines 91 flowing in the magnetic material of magnetic core 11 are illustrated. As is clear from FIGS. 3B and 3C, magnetic flux lines 91 leaking to coil end portions 12a and 12b (referred to as both end portions of coil 12 in an up-down direction) are interlinked with the coil to generate the eddy current. That is, with the size reduction of the rotary electrical machine, magnetic core 11 of stator 10 becomes small, and magnetic saturation easily occurs. As a result, leakage magnetic flux to the coil end portions increases, and an eddy current loss increases.

### First Exemplary Embodiment

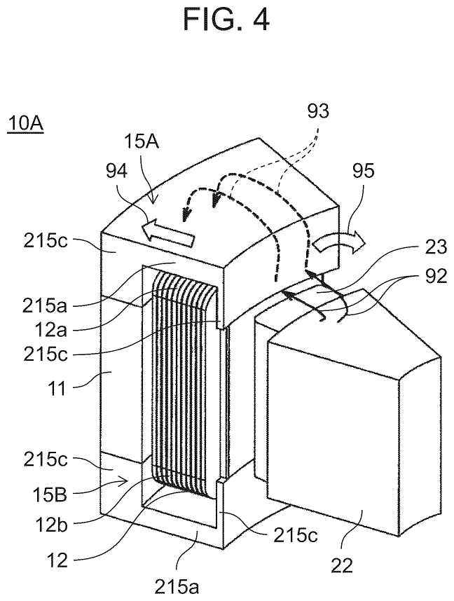

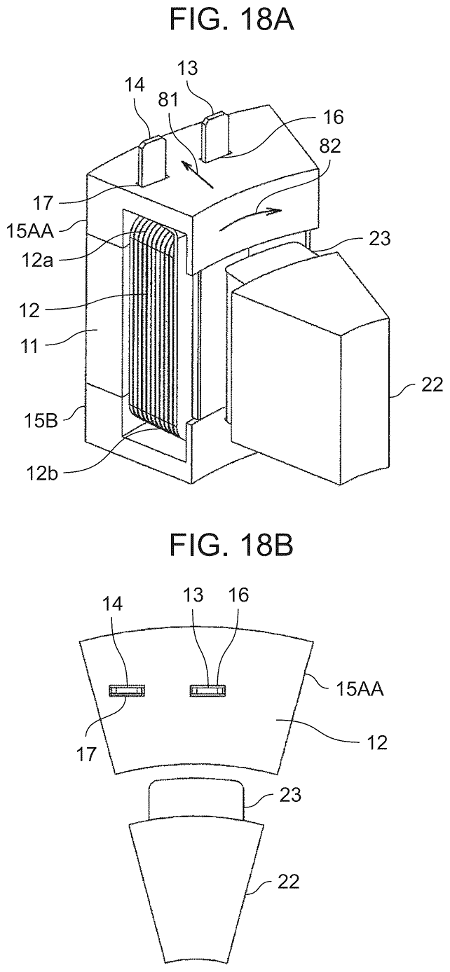

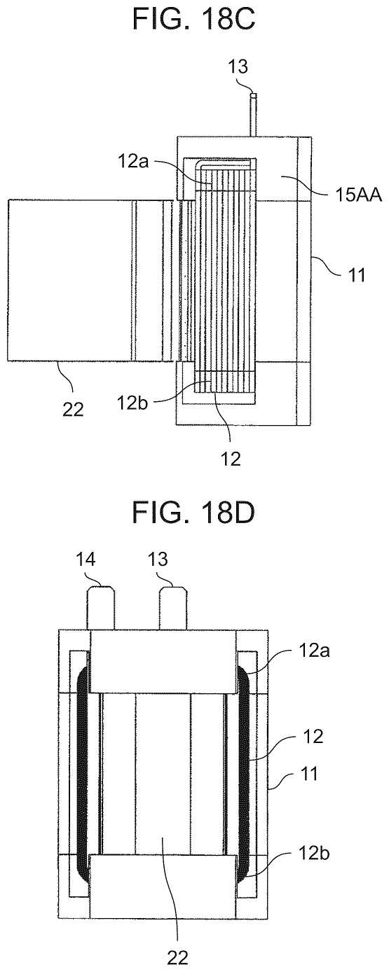

FIG. 4 is a perspective view illustrating a configuration example of one sector 10A of a rotary electrical machine according to a first exemplary embodiment, and details of a structure are illustrated in FIGS. 18A to 18D. As compared with one sector 10C of the rotary electrical machine of FIG. 3C, one sector 10A of the rotary electrical machine of FIG. 4 is characterized in that magnetic structures 15A and 15B that attract leakage magnetic flux not to interlink the leakage magnetic flux with coil 12 are provided in coil end portions 12a and 12b, respectively. Note that, magnetic structures 15A and 15B are provided, for example, in all sectors of the rotary electrical machine, but the present disclosure is not limited thereto, and may be provided in some sectors.

Each of magnetic structures 15A and 15B includes flat base 115a extending in a radial direction and a circumferential direction, and legs 215b and 215c (each of which is curved to face an outer peripheral surface and an inner peripheral surface) coupled to both end portions of flat base 215a in the radial direction and extending in an up-down thickness direction (a direction parallel to the axial direction of the rotary electrical machine), and thus, the magnetic structures are configured to cover coil end portions 12a and 12b of coil 12 from above and below.

In the first exemplary embodiment, magnetic core 11 is made of a magnetic material such as an electromagnetic steel sheet such as silicon steel, and has a relative permeability of about 4000 to 50,000. Note that, in a simulation, the relative permeability is set to 5000. In addition, magnetic structure 15 is made of, for example, a powder magnetic material such as ferrite, and has a relative permeability of about 100 to 2000. Note that, in the simulation, the relative permeability is set to 1000.

In FIG. 4, magnetic flux lines generated from permanent magnet 23 is directed to coil 12 as indicated by reference mark 92, and leakage magnetic flux of a part of the magnetic flux line is generated as indicated by a magnetic flux line 93. That is, magnetic flux lines 93 leaking at coil end portions 12a and 12b interlink coil 12 to generate the eddy current. Here, magnetic structures 15A and 15B, which are magnetic materials having high permeability, are configured to attract leakage magnetic flux lines 93 such that magnetic flux lines 93 do not substantially interlink with coil 12.

In a rotating magnetic field in the rotary electrical machine having the above configuration, it is considered that an effect of guiding leakage magnetic flux lines 93 in radial direction 94 and an effect of guiding leakage magnetic flux lines 93 in circumferential direction 95 are necessary.

Next, results of the simulation performed by the inventors will be described below.

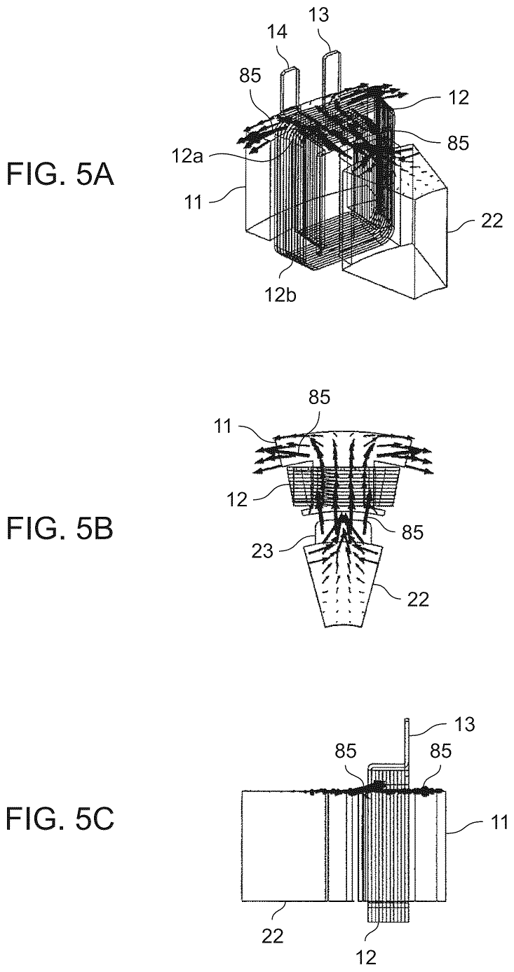

FIG. 5A is a see-through perspective view of one sector of the rotary electrical machine illustrating magnetic flux density vectors 85 of the magnetic flux lines leaking to coil end portions 15a and 15b when a rotation angle of the rotor is 0 degrees, which is a simulation result of the rotary electrical machine of FIG. 1A according to the comparative example, FIG. 5B is a see-through top view of the simulation result of FIG. 5A, and FIG. 5C is a see-through side view of the simulation result of FIG. 5A.

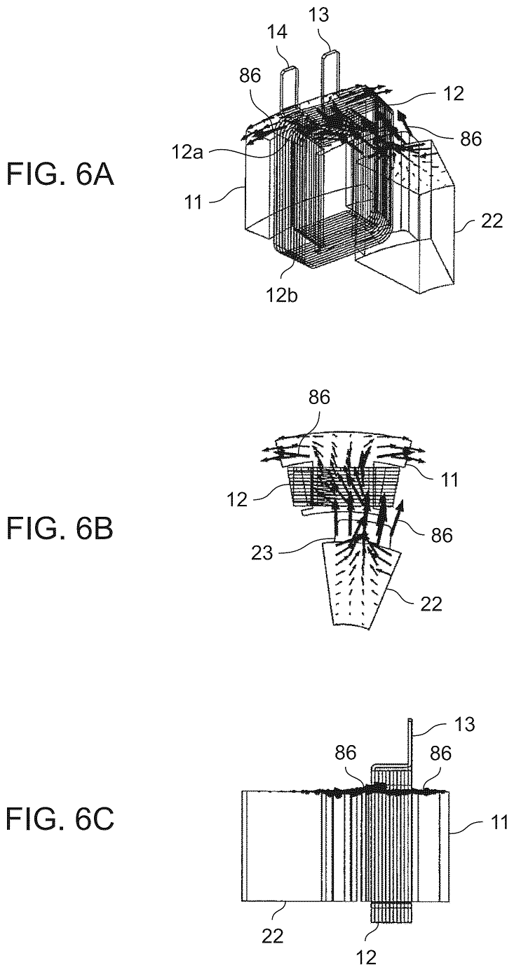

FIG. 6A is a see-through perspective view of one sector of the rotary electrical machine illustrating magnetic flux density vectors 86 of the magnetic flux lines leaking to coil end portions 15a and 15b when the rotation angle of the rotor is 7.5 degrees, which is a simulation result of the rotary electrical machine of FIG. 1A, FIG. 6B is a see-through top view of the simulation result of FIG. 6A, and FIG. 6C is a see-through side view of the simulation result of FIG. 6A.

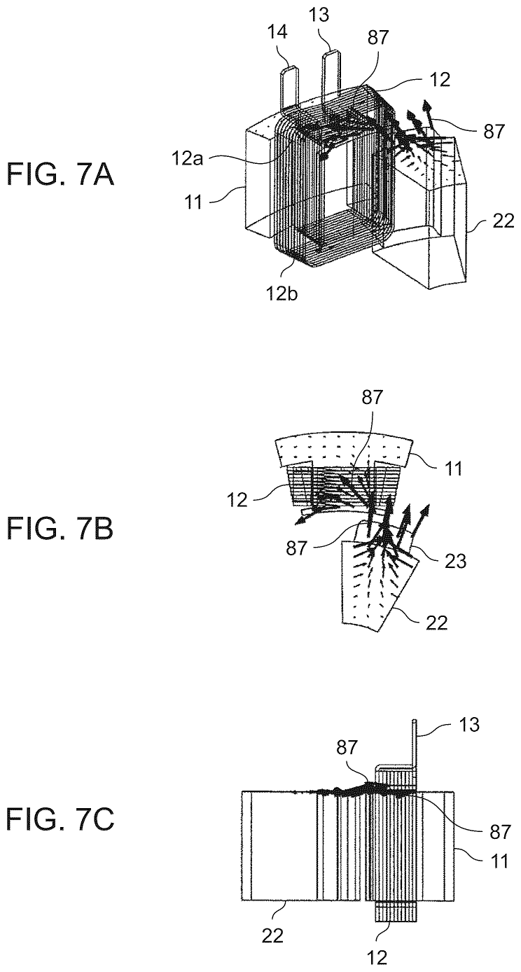

FIG. 7A is a see-through perspective view of one sector of the rotary electrical machine illustrating magnetic flux density vectors 87 of the magnetic flux lines leaking to coil end portions 15a and 15b when the rotation angle of the rotor is 15 degrees, which is a simulation result of the rotary electrical machine of FIG. 1A, FIG. 7B is a see-through top view of the simulation result of FIG. 7A, and FIG. 7C is a see-through side view of the simulation result of FIG. 7A.

In FIGS. 5A to 5C, FIGS. 6A to 6C, and FIGS. 7A to 7C, the simulation results of magnetic flux density vectors 85 to 87 of the magnetic flux lines leaking into coil end portions 15a and 15b are time-resolved by animation and displayed. From these drawings, it can be seen that the leakage magnetic flux is remarkable in coil end portions 15a and 15b.

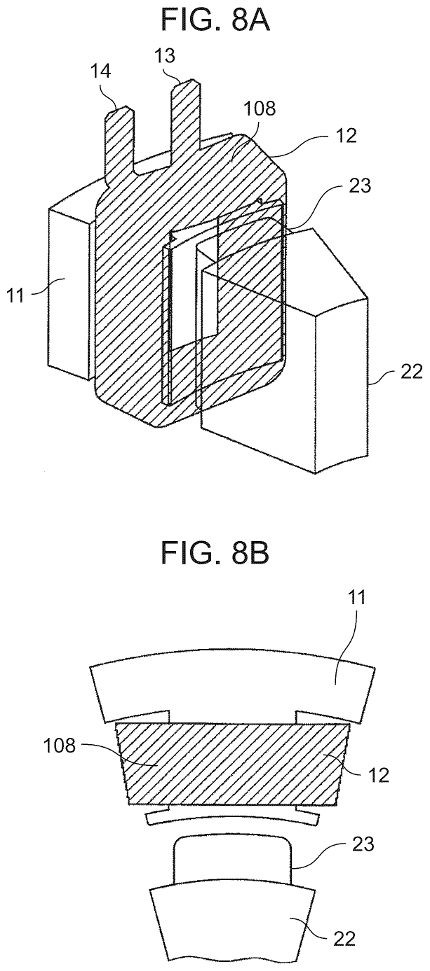

FIG. 8A is a see-through perspective view of one sector of the rotary electrical machine illustrating an analysis result of an eddy current in a coil in a rotating magnetic field by a magnet of the rotor, which is a simulation result of the rotary electrical machine of FIG. 1A, and FIG. 8B is a see-through top view of the simulation result of FIG. 8A.

In FIGS. 8A and 8B, an eddy current distribution in coil 12 in the rotating magnetic field by permanent magnet 23 of rotor 20 is indicated by hatching. As is clear from FIGS. 8A and 8B, it can be seen that the generation of the eddy currents is extremely large in coil end portions 15a and 15b.

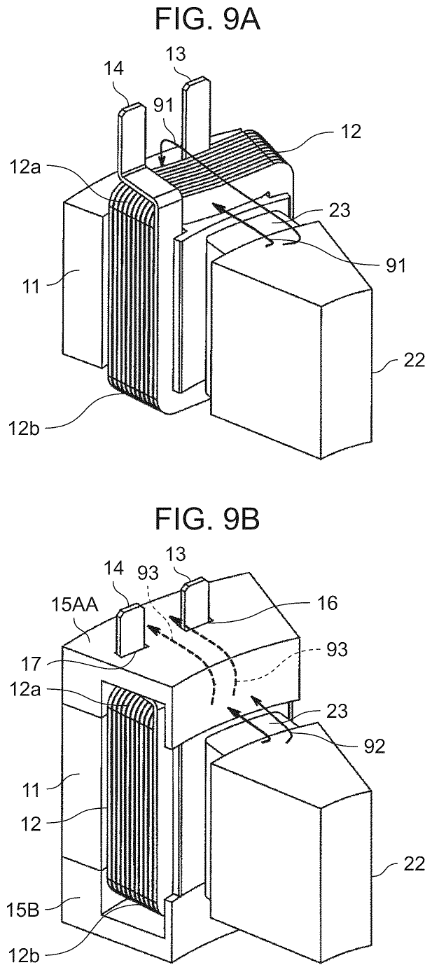

FIG. 9A is a perspective view illustrating a configuration of one sector of the rotary electrical machine according to the comparative example, and FIG. 9B is a perspective view illustrating a configuration of one sector of the rotary electrical machine according to the first exemplary embodiment. In the rotary electrical machine according to the comparative example of FIG. 9A, leakage magnetic flux lines 91 are generated. In the rotary electrical machine according to the first exemplary embodiment of FIG. 9B, magnetic structure 15AA mounted on coil end portions 15a and 15b has through-holes 16 and 17 penetrating through magnetic structure 15AA in the up-down direction in order to cause terminals 13 and 14 to protrude upward, respectively, as compared with magnetic structure 15A of FIG. 4.

In the rotary electrical machine having the above configuration, generated leakage magnetic flux lines 93 are attracted and confined in magnetic structure 15AA by magnetic structure 15AA, and thus, it is possible to reduce leakage magnetic flux lines 93 and significantly reduce the eddy current loss.

Next, simulation results of a current density distribution in the comparative example and the first exemplary embodiment will be described below.

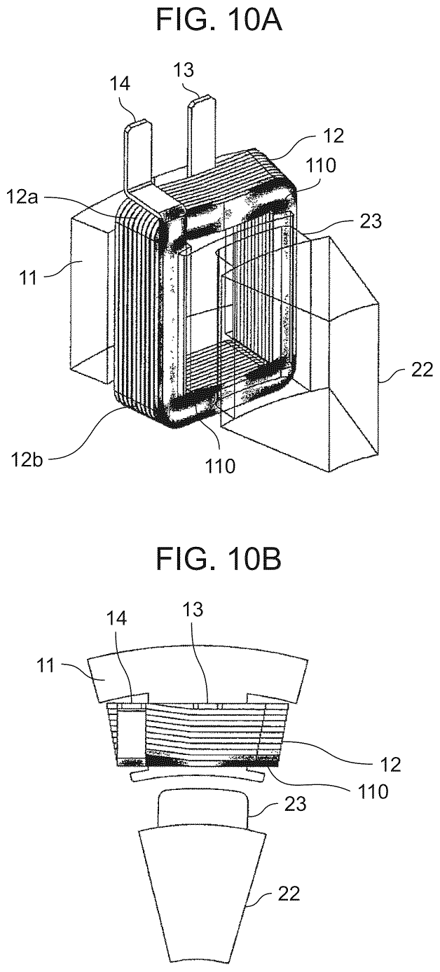

FIG. 10A is a perspective view illustrating a distribution in which the current density is 1×10⁶ (A/m²) or more when the rotation angle of the rotor is 0 degrees by monochrome contour line display, which is a simulation result of one sector of the rotary electrical machine of FIG. 9A, and FIG. 10B is a top view of the simulation result of FIG. 10A. Here, the current density distribution is indicated by reference mark 110.

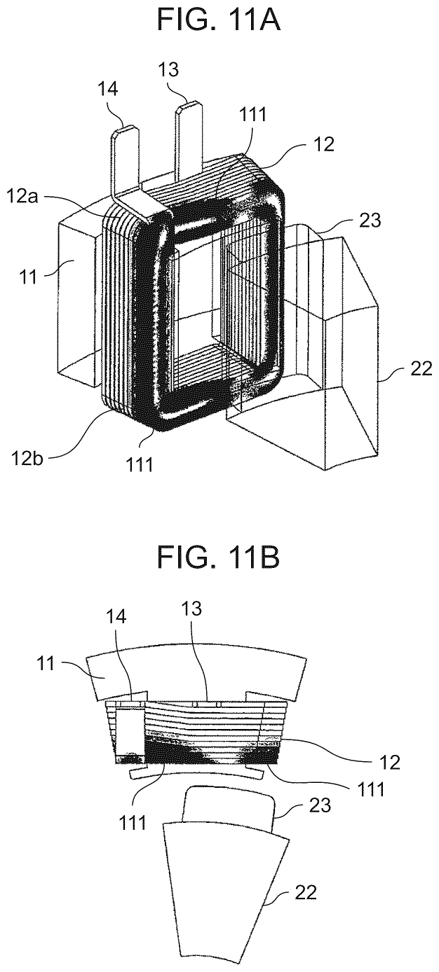

FIG. 11A is a perspective view illustrating a distribution in which the current density is 1×10⁶ (A/m²) or more when the rotation angle of the rotor is 7.5 degrees by monochrome contour line display, which is a simulation result of one sector of the rotary electrical machine of FIG. 9A, and FIG. 11B is a top view of the simulation result of FIG. 11A. Here, the current density distribution is indicated by reference mark 111.

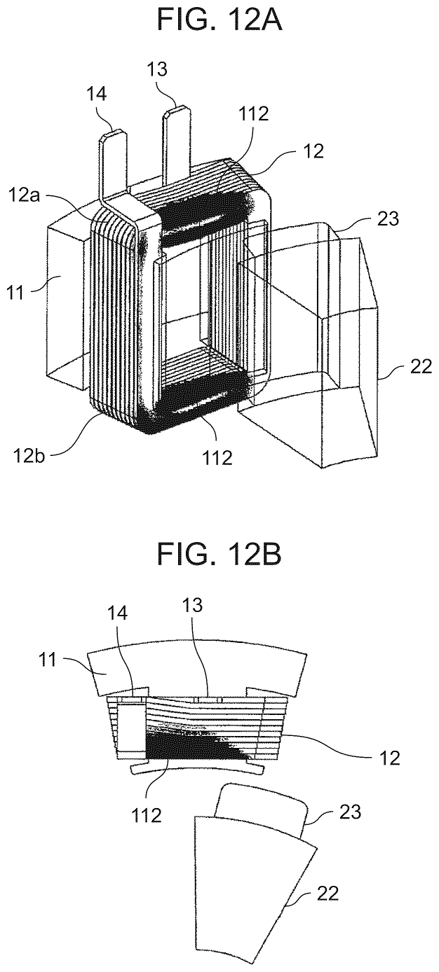

FIG. 12A is a perspective view illustrating a distribution in which the current density is 1×10⁶ (A/m²) or more when the rotation angle of the rotor is 15 degrees by monochrome contour line display, which is a simulation result of one sector of the rotary electrical machine of FIG. 9A, and FIG. 12B is a top view of the simulation result of FIG. 12A. Here, the current density distribution is indicated by reference mark 112.

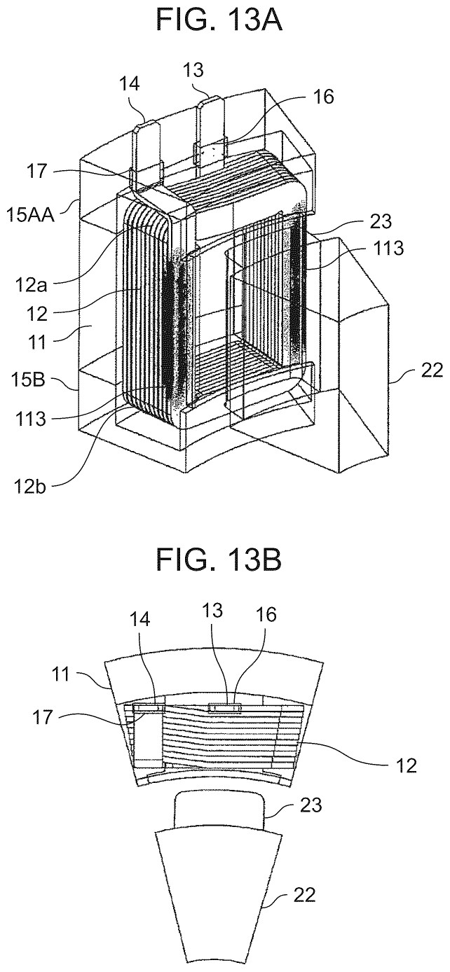

FIG. 13A is a perspective view illustrating a distribution in which the current density is 1×10⁶ (A/m²) or more when the rotation angle of the rotor is 0 degrees by monochrome contour line display, which is a simulation result of one sector of the rotary electrical machine of FIG. 9B, and FIG. 13B is a top view of the simulation result of FIG. 13A. Here, the current density distribution is indicated by reference mark 113.

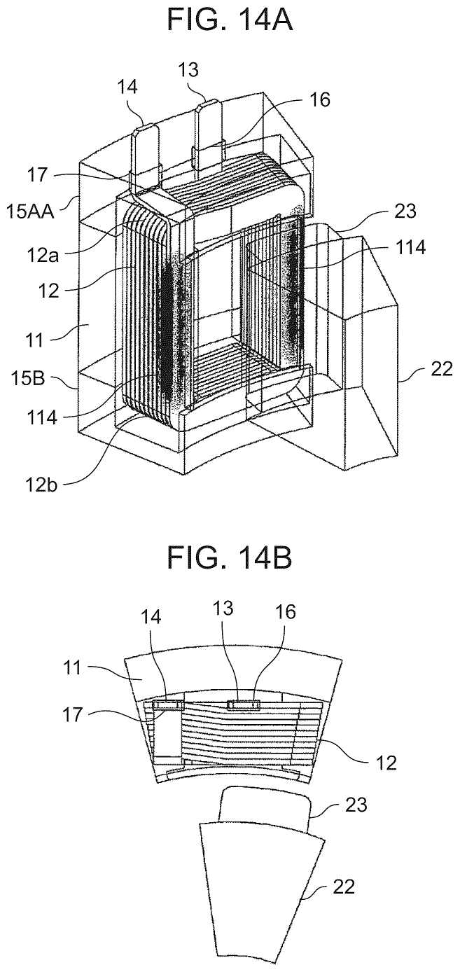

FIG. 14A is a perspective view illustrating a distribution in which the current density is 1×10⁶ (A/m²) or more when the rotation angle of the rotor is 7.5 degrees by monochrome contour line display, which is a simulation result of one sector of the rotary electrical machine of FIG. 9B, and FIG. 14B is a top view of the simulation result of FIG. 14A. Here, the current density distribution is indicated by reference mark 114.

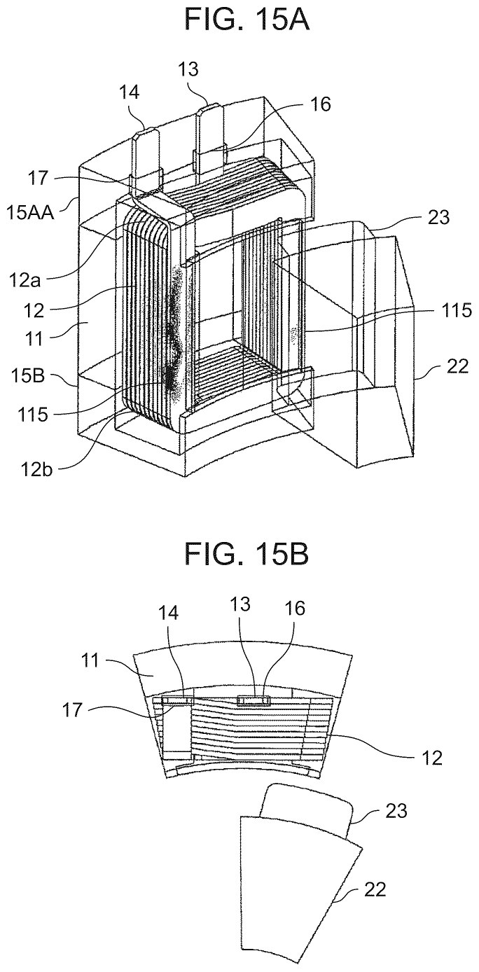

FIG. 15A is a perspective view illustrating a distribution in which the current density is 1×10⁶ (Nm²) or more when the rotation angle of the rotor is 15 degrees by monochrome contour line display, which is a simulation result of one sector of the rotary electrical machine of FIG. 9B, and FIG. 15B is a top view of the simulation result of FIG. 15A. Here, the current density distribution is indicated by reference mark 115.

As is apparent from the simulation results according to the comparative examples of FIGS. 10A to 12B, in the comparative example not including magnetic structures 15A and 15B, current density distributions 110 to 112 having a current density of 1×10⁶ (A/m²) or more are generated particularly near coil end portions 15a and 15b. On the other hand, as is clear from the simulation results according to first exemplary embodiment in FIGS. 13A to 15B, in the first exemplary embodiment including magnetic structures 15A and 15B, current density distributions 113 to 115 having a current density of 1-10⁶ (A/m²) or more are not generated particularly near coil end portions 15a and 15b.

Next, simulation results of a current density distribution in the comparative example and the first exemplary embodiment will be described below.

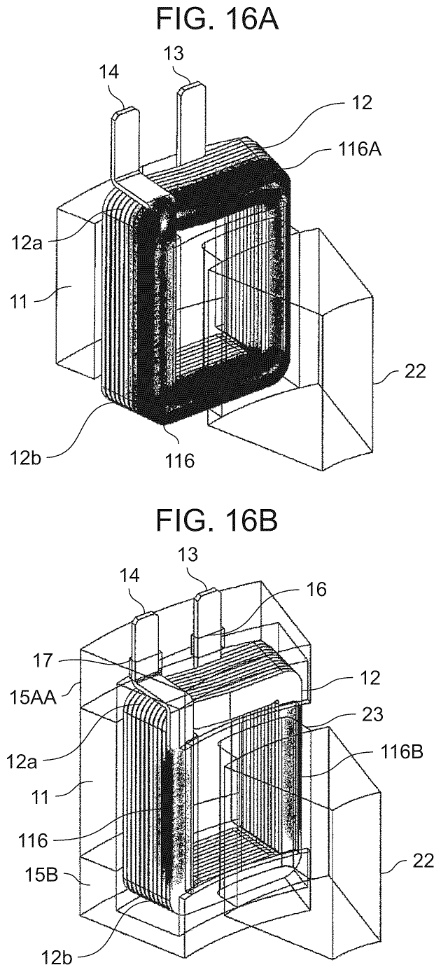

FIG. 16A is a perspective view illustrating a distribution in which an eddy current loss per unit area is 1×10⁴ (W/m³) or more by monochrome contour line display, which is a simulation result of one sector of the rotary electrical machine of FIG. 9A, and an eddy current loss distribution is indicated by reference mark 116A. In addition, FIG. 16B is a perspective view illustrating a distribution in which the eddy current loss per unit area is 1×10⁴ (W/m³) or more by monochrome contour line display, which is a simulation result of one sector of the rotary electrical machine of FIG. 9B, and the eddy current loss distribution is indicated by reference mark 116B.

The eddy current loss of the rotary electrical machine according to the comparative example of FIG. 16A is generated particularly in coil end portions 15a and 15a. On the other hand, it can be seen that the eddy current loss is not generated in the rotary electrical machine according to the first exemplary embodiment of FIG. 16B particularly in coil end portions 15a and 15b.

As described above, in accordance with the rotary electrical machine according to the first exemplary embodiment, magnetic structure 15A or 15AA or 15B that induce the leakage magnetic flux in radial direction 81 in FIG. 18A and attract the leakage magnetic flux in circumferential direction 82 in FIG. 18A are provided in coil end portions 15a and 15b, and thus, the leakage magnetic flux lines and the eddy current losses in coil end portions 15a and 15b can be significantly reduced as compared with the comparative example. As a result, a loss of the coil 15 can be significantly reduced.

### Second Exemplary Embodiment

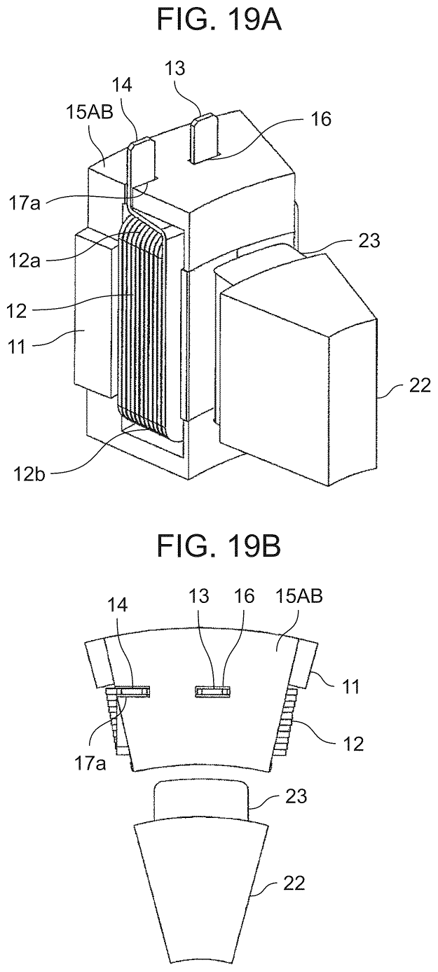

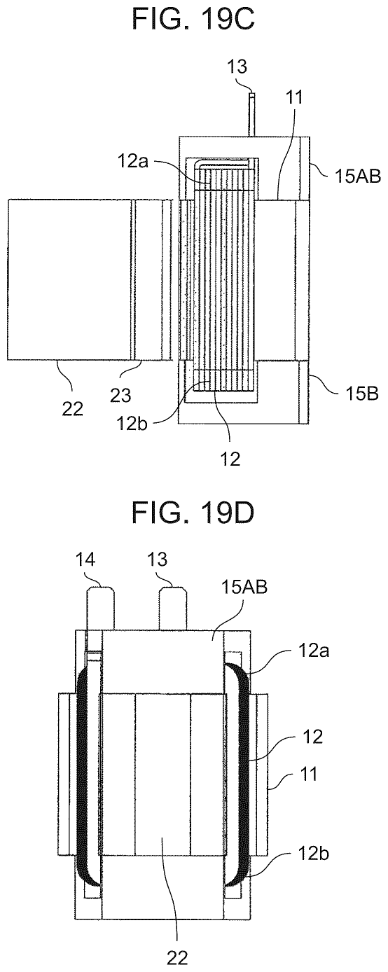

FIG. 19A is a perspective view illustrating a configuration of one sector of a rotary electrical machine according to a second exemplary embodiment, and FIG. 19B is a top view of the rotary electrical machine of FIG. 19A. In addition, FIG. 19C is a side view of the rotary electrical machine of FIG. 19A, and FIG. 19D is a front view of the rotary electrical machine of FIG. 19A. In the drawings of the rotary electrical machine in the second and subsequent exemplary embodiments and modifications, one sector is illustrated, but a plurality of sectors are used in combination as in the first exemplary embodiment in the case of constituting the rotary electrical machine.

The rotary electrical machine of FIGS. 19A to 19D is different from the rotary electrical machine of FIGS. 18A to 18D in the following points. (1) Magnetic structure 15AB having through-holes 16 and 17a is provided instead of magnetic structure 15AA having through-holes 16 and 17. That is, through-hole 17a is formed instead of through-hole 17 through which terminal 14 penetrates. Hereinafter, differences will be described.

In FIGS. 19A and 19B, through-hole 17a is also formed to penetrate through a side surface of magnetic structure 15AB facing a surface of an adjacent sector in the circumferential direction. As a result, magnetic structure 15A provided in coil end portion 15a becomes discontinuous in the circumferential direction, and an action of attracting the leakage magnetic flux in the circumferential direction is reduced as compared with the first exemplary embodiment, and an effect of reducing the eddy current loss is slightly reduced. However, the second exemplary embodiment has the following actions and effects.

In accordance with the second exemplary embodiment having the above configuration, magnetic structures 15AB and 15B are provided in coil end portions 15a and 15b, respectively, and thus, the leakage magnetic flux lines and the eddy current losses in coil end portions 15a and 15b can be reduced as compared with the comparative example. As a result, the loss of the coil 15 can be reduced.

### Third Exemplary Embodiment

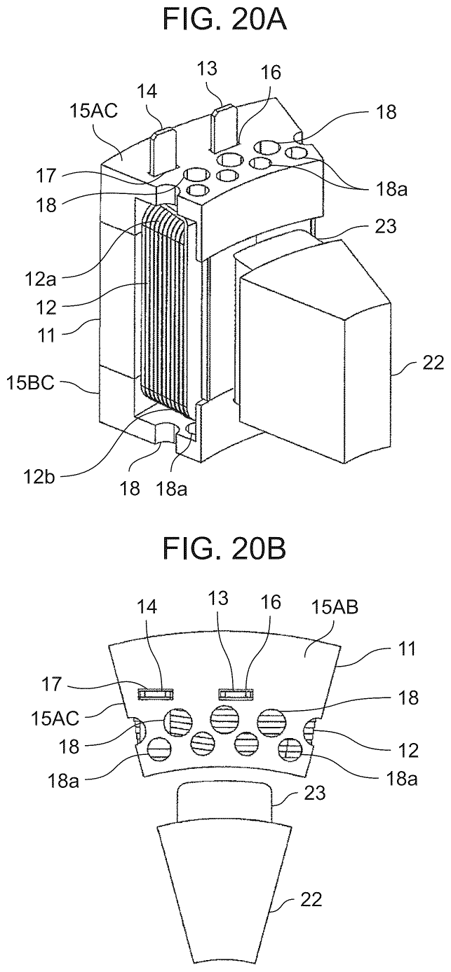

FIG. 20A is a perspective view illustrating a configuration of one sector of a rotary electrical machine according to a third exemplary embodiment, and FIG. 20B is a top view of the rotary electrical machine of FIG. 20A. The rotary electrical machine of FIGS. 20A to 20B is different from the rotary electrical machine of FIGS. 18A to 18D in the following points. (1) Magnetic structure 15AC having through-holes 16 and 17 and a plurality of cooling through-holes 18 and 18a is provided instead of magnetic structure 15AA having through-holes 16 and 17. Here, through-holes 16 and 17 are formed similarly to the rotary electrical machine of FIGS. 18A to 18D. (2) Magnetic structure 15BC having a plurality of cooling through-holes 18 and 18a is provided Instead of magnetic structure 15B. Hereinafter, differences will be described.

In FIGS. 20A and 20B, cooling through-holes 18 and 18a are formed in, for example, a columnar shape to penetrate through the up-down thickness direction of magnetic structures 15AC and 15BC (direction parallel to the axial direction of the rotary electrical machine) between through-holes 16 and 17 and inner peripheral surfaces of magnetic structures 15AC and 15BC in order to release heat generated by coil 12 to an outside. In an example of the third exemplary embodiment, a diameter of cooling through-hole 18 is formed to be larger than a diameter of cooling through-hole 18a, but the present disclosure is not limited thereto. Note that, in the third exemplary embodiment, an effect of attracting the leakage magnetic flux in the radial direction is slightly reduced by the formation of the plurality of cooling through-holes 18 and 18a as compared with first exemplary embodiment.

In accordance with the third exemplary embodiment having the above configuration, since the plurality of cooling through-holes 18 and 18a are formed in magnetic structures 15AC and 15BC, the heat generation of coil 12 can be released to the outside, and effects similar to the effects of the first exemplary embodiment are obtained.

### Fourth Exemplary Embodiment

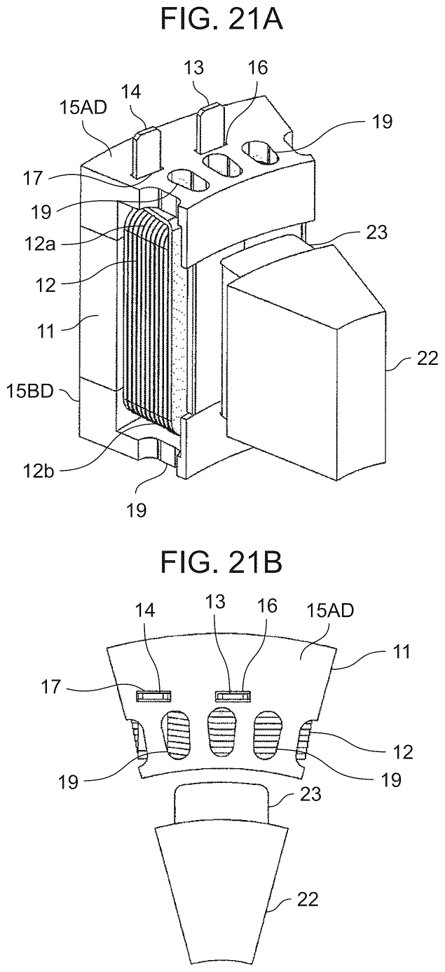

FIG. 21A is a perspective view illustrating a configuration of one sector of a rotary electrical machine according to a fourth exemplary embodiment, and FIG. 21B is a top view of the rotary electrical machine of FIG. 21A. The rotary electrical machine of FIGS. 21A to 21B is different from the rotary electrical machine of FIGS. 18A to 18D in the following points. (I) Magnetic structure 15AD having through-holes 16 and 17 and a plurality of cooling through-holes 19 is provided instead of magnetic structure 15AA having through-holes 16 and 17. Here, through-holes 16 and 17 are formed similarly to the rotary electrical machine of FIGS. 18A to 18D. (2) Magnetic structure 15BD having a plurality of cooling through-holes 19 is provided instead of magnetic structure 15B. Hereinafter, differences will be described.

In FIGS. 21A and 21B, in order to release heat generated by coil 12 to an outside, cooling through-holes 19 and 19 are formed in, for example, an elliptic columnar shape to penetrate through the up-down thickness direction of magnetic structures 15AD and 15BD (direction parallel to the axial direction of the rotary electrical machine) between through-holes 16 and 17 and inner peripheral surfaces of magnetic structures 15AD and 15BD. Note that, in the fourth exemplary embodiment, as compared with first exemplary embodiment, an effect of attracting the leakage magnetic flux in the radial direction is slightly reduced by the formation of the plurality of cooling through-holes 19 and 19.

In accordance with the fourth exemplary embodiment having the above configuration, since the plurality of cooling through-holes 19 and 19 are formed in magnetic structures 15AD and 15BD, the heat generation of coil 12 can be released to the outside, and effects similar to the effects of the first exemplary embodiment are obtained.

### Fifth Exemplary Embodiment

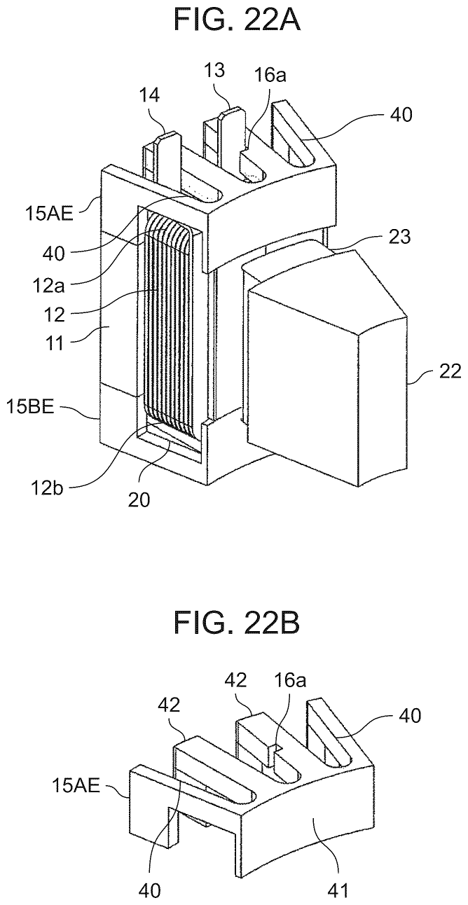

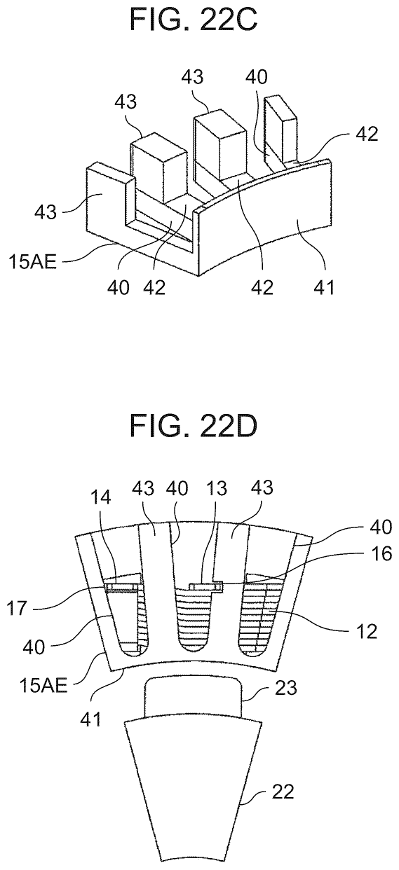

FIG. 22A is a perspective view illustrating a configuration of one sector of a rotary electrical machine according to a fifth exemplary embodiment, and FIG. 22B is a perspective view of a magnetic structure of the rotary electrical machine of FIG. 22A. In addition, FIG. 22C is a perspective view of the magnetic structure of the rotary electrical machine of FIG. 22A when the magnetic structure is turned upside down, and FIG. 22D is a top view of the rotary electrical machine of FIG. 22A. The rotary electrical machine of FIGS. 22A to 22D is different from the rotary electrical machine of FIGS. 18A to 18D in the following points. (1) Magnetic structure 15AE having through-hole 16a and a plurality of cooling through-holes 40 is provided instead of magnetic structure 15AA having through-holes 16 and 17. (2) Magnetic structure 15BE having a plurality of cooling through-holes 40 is provided instead of magnetic structure 15B. Hereinafter, differences will be described.

In FIGS. 22A to 22D, in order to release heat generated by coil 12 to the outside, cooling through-holes 40 and 40 are formed in, for example, a substantially semi-elliptic columnar shape in which an elliptic axis extends in the radial direction of magnetic structures 15AE and 15BE from a position slightly inside from inner peripheral surfaces of magnetic structures 15AE and 15BE to outer peripheral surfaces thereof. Here, magnetic structure 15AE is a comb-shaped structure, and includes a curved base 41 positioned on an inner peripheral surface thereof, a plurality of comb-shaped portions 42 extending in the radial direction from curved base 41, and legs 43 coupled to positions coming into contact with outer peripheral surfaces of comb-shaped portions 42, and cooling through-holes 40 are formed between adjacent comb-shaped portions 42. In addition, magnetic structure 15BE is formed similarly to magnetic structure 15AE except that magnetic structure 15BE does not have through-hole 16a. Note that, in the fifth exemplary embodiment, as compared with the first exemplary embodiment, the effect of attracting the leakage magnetic flux in the radial direction is slightly reduced by the formation of the plurality of cooling through-holes 40 and 40, and a large opening hole can be formed with respect to the outer peripheral surface.

In accordance with the fifth exemplary embodiment having the above configuration, since the plurality of cooling through-holes 40 and 40 are formed in magnetic structures 15AE and 15BE, the heat generation of coil 12 can be released to the outside, and effects similar to the effects of the first exemplary embodiment are obtained.

### Sixth Exemplary Embodiment

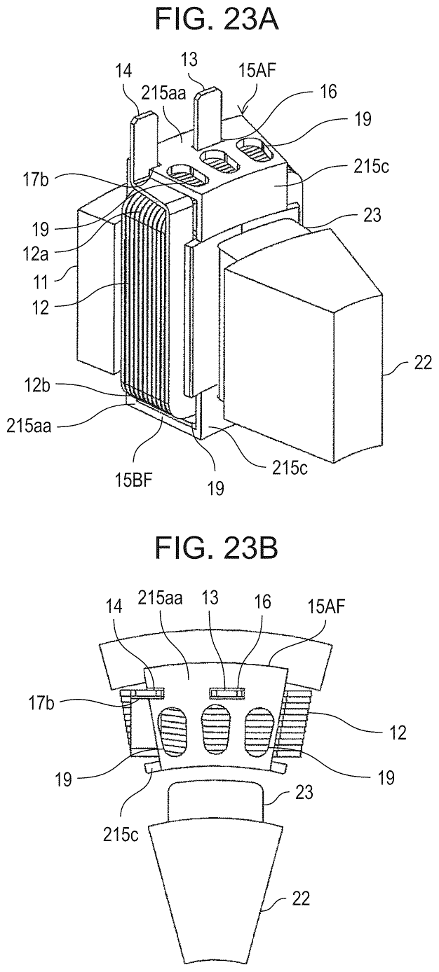

FIG. 23A is a perspective view illustrating a configuration of one sector of a rotary electrical machine according to a sixth exemplary embodiment, and FIG. 23B is a top view of the rotary electrical machine of FIG. 23A. The rotary electrical machine of FIGS. 23A to 23B is different from the rotary electrical machine of FIGS. 21A to 21B in the following points. (1) Magnetic structure 15AF having through-holes 16 and 17 and a plurality of cooling through-holes 19 is provided instead of magnetic structure 15AD having through-holes 16 and 17. Here, through-holes 16 and 17 are formed similarly to the rotary electrical machine of FIGS. 21A to 21B. (2) Magnetic structure 15BF having a plurality of cooling through-holes 19 is provided instead of magnetic structure 15BD. Hereinafter, differences will be described.

In FIGS. 23A and 23B, cooling through-holes 19 and 19 are formed similarly to FIGS. 21A and 21B, but each of magnetic structures 15AF and 15BF includes flat base 215aa having a shorter length in the radial direction and a thinner thickness than flat base 215a in FIG. 4 and legs 215c extending in a direction parallel to the axial direction from an inner peripheral surface portion thereof, and a plurality of cooling through-holes 19 are formed in flat base 215aa. Note that, in the sixth exemplary embodiment, as compared with the fourth exemplary embodiment, an effect of attracting the leakage magnetic flux in the radial direction is slightly reduced by the formation of the plurality of cooling through-holes 19 and 19. Cost can be reduced by reducing the thicknesses of flat bases 215aa of magnetic structures 15AF and 15BF and dispersedly disposing the plurality of cooling through-holes 19 and 19 in the circumferential direction.

In accordance with the sixth exemplary embodiment having the above configuration, since the plurality of cooling through-holes 19 and 19 are formed in magnetic structures 15AF and 15BF, the heat generation of coil 12 can be released to the outside, and effects similar to the effects of the fourth exemplary embodiment are obtained.

Note that, as compared with the fourth exemplary embodiment, since the action of attracting the leakage magnetic flux of coil end portions 12a and 12b in the radial direction is reduced and the action of attracting the leakage magnetic flux in the circumferential direction is also reduced, the loss reduction effect is reduced.

### Seventh Exemplary Embodiment

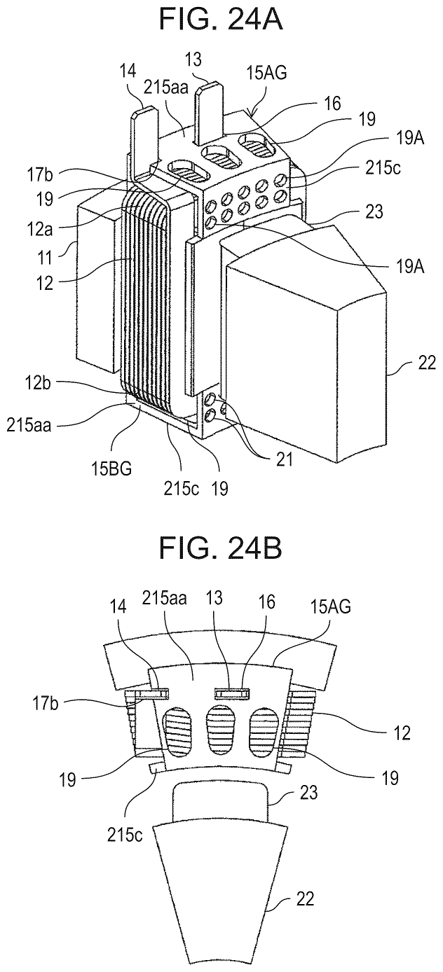

FIG. 24A is a perspective view illustrating a configuration of one sector of a rotary electrical machine according to a seventh exemplary embodiment, and FIG. 24B is a top view of the rotary electrical machine of FIG. 24A. The rotary electrical machine of FIGS. 24A and 24B is different from the rotary electrical machine of FIGS. 23A and 23B in the following points.

(1) A plurality of cooling through-holes 19A having, for example, a columnar shape are further formed in leg 215c. Here, cooling through-holes 19A are formed to penetrate through leg 215c in the radial direction.

Hereinafter, differences will be described.

In accordance with the seventh exemplary embodiment having the above configuration, cooling through-holes 19 and 19A are increased as compared with the fourth exemplary embodiment, the cost can be reduced by reducing the thicknesses of flat base 215aa of magnetic structures 15AG and 15BG are reduced as compared with the first exemplary embodiment and dispersedly disposing cooling through-holes 19 and 19A in the circumferential direction. However, cooling through-holes 19A are provided near rotor 20 having a large leakage magnetic field in the circumferential direction, and thus, the action of attracting the leakage magnetic field in the circumferential direction is reduced as compared with the fourth exemplary embodiment, and the loss reduction effect is reduced.

### Other Modifications

In the above exemplary embodiments and modifications, magnetic structures 15A, 15AA to 15AG, 15B, and 15BC to 15BG are provided at both ends of coil end portions 15a and 15b, respectively. However, the present disclosure is not limited thereto, and the magnetic structures may be provided at at least one of both the ends of coil end portions 15a and 15b.

In the sixth and seventh exemplary embodiments described above, cooling through-holes 19 and 19A are formed, but the present disclosure is not limited thereto, and at least one of cooling through-holes 19 and 19A may not be formed.

### Example

Table 1 below shows results of calculation of the eddy current losses by the simulation for the rotary electrical machines according to the above-described comparative examples and exemplary embodiments.

TABLE 1

| | Eddy current loss |
|---|---|
| | (mW) |
| Comparative Example | 188.4 |
| First exemplary embodiment | 32.0 |
| Second exemplary embodiment | 39.3 |
| Fifth exemplary embodiment | 42.2 |

As is clear from Table 1, in these four cases, the eddy current loss of the first exemplary embodiment is the smallest, and the eddy current loss of the comparative example is the largest. That is, it can be seen that the loss reduction is reduced by setting the inductivity of the leakage magnetic flux in the circumferential direction to be discontinuous.

### INDUSTRIAL APPLICABILITY

As described above in detail, in accordance with the rotary electrical machine according to one aspect of the present disclosure, an increase in an induced electromotive force (electromotive force of the eddy current) due to the leakage magnetic flux in the coil end portions and an increase in the leakage magnetic flux in the coil end portions by the size reduction are suppressed. Thus, the eddy current loss in the coil can be reduced, and thus, the loss of the coil can be significantly reduced.

### REFERENCE MARKS IN THE DRAWINGS

1: rotary electrical machine
10: stator
10A, 10C: one sector of rotor
11: magnetic core
12: coil
12a, 12b: coil end portion
13, 14: terminal
15A, 15AA to 15AG, 15B, 15BC-15BG: magnetic structure
16, 16a, 17, 17a, 17b: through-hole
18, 18a, 19, 19A: cooling through-hole
20: rotor
21: rotary shaft
22: magnetic core
23: permanent magnet
41: curved base
42: comb-shaped portion
43: leg
215a, 215aa: flat base
215b, 215c: leg

1. A rotary electrical machine that includes a stator including a coil and a first magnetic core, and a rotor including a permanent magnet and a second magnetic core, the rotary electrical machine comprising:
a magnetic structure provided in at least one of two coil end portions that are both ends of the coil, the magnetic structure inducing magnetic flux directed from the second magnetic core to the first magnetic core.

2. The rotary electrical machine according to claim 1, wherein the magnetic structure guides the magnetic flux directed from the second magnetic core to the first magnetic core in a radial direction of the rotary electrical machine and guides the magnetic flux in a circumferential direction of the rotary electrical machine.

3. The rotary electrical machine according to claim 1, wherein the magnetic structure is provided to prevent the magnetic flux from substantially interlinking with the coil.

4. The rotary electrical machine according to claim 1, wherein the magnetic structure includes a plurality of first cooling through-holes penetrating through the magnetic structure in a direction parallel to an axial direction of the rotary electrical machine.

5. The rotary electrical machine according to claim 4, wherein the plurality of first cooling through-holes are formed in the magnetic structure to extend from a position near an inner peripheral surface of the stator to an outer peripheral surface of the stator.

6. The rotary electrical machine according to claim 4, wherein the magnetic structure includes a plurality of second cooling through-holes penetrating through the magnetic structure in a direction parallel to a radial direction of the rotary electrical machine.

7. The rotary electrical machine according to claim 1, wherein the magnetic structure includes a flat base extending from an inner peripheral surface to an outer peripheral surface of the stator, and a pair of legs extending from both ends of the flat base in a radial direction in an axial direction of the rotary electrical machine.

8. The rotary electrical machine according to claim 7, wherein the magnetic structure includes a plurality of first cooling through-holes penetrating through the flat base in a direction parallel to the axial direction of the rotary electrical machine.

9. The rotary electrical machine according to claim 1, wherein the magnetic structure includes a flat base extending from an inner peripheral surface to an outer peripheral surface of the stator, and a leg extending in an axial direction of the rotary electrical machine from one end of the flat base on an inner peripheral surface side in a radial direction.

10. The rotary electrical machine according to claim 9, wherein the magnetic structure includes a plurality of first cooling through-holes penetrating through the flat base in a direction parallel to the axial direction of the rotary electrical machine.

11. The rotary electrical machine according to claim 10, wherein the magnetic structure includes a plurality of second cooling through-holes penetrating through the leg in a direction parallel to a radial direction of the rotary electrical machine.
